(19) United States
(12) Patent Application Publication
(10) Pub. No.: US 2025/0032934 A1
(43) Pub. Date: Jan. 30, 2025

(54) TIDE EVALUATION DEVICE, TIDE EVALUATION METHOD, AND PROGRAM

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 18/913,424

(22) Filed: Oct. 11, 2024

Related U.S. Application Data
(63) Continuation of application No. PCT/JP2023/014068, filed on Apr. 5, 2023.

(30) Foreign Application Priority Data
Apr. 11, 2022 (JP) 2022-065152

(51) Int. Cl. A63F 13/79; A63F 3/00

(52) U.S. Cl. CPC A63F 13/79; A63F 3/00075

(57) ABSTRACT

A tide evaluation device may include a reference-data storage unit that stores reference data, the reference data being data generated based on log data of various game plays executed in the past, and the reference data including various combinations of reference state information representing a game state in a game play and a game result determined following the game state; an acquisition unit that acquires subject state information representing a game state at a timing for evaluating a game play to be evaluated; a search unit that extracts the reference state information similar to the subject state information from among the reference data; an evaluation unit that evaluates the tide of a game at the timing for evaluating the game play to be evaluated based on the game results associated with the reference state information extracted; and an output unit that outputs the result of the evaluation.

### TECHNICAL FIELD

The present invention relates to tide evaluation devices, tide evaluation methods, and programs.

### BACKGROUND ART

Recently, webcasting of shogi games is gaining popularity. In the webcasting, tide evaluation (which player has an advantage) based on shogi artificial intelligence (AI) is displayed in real time, which makes it possible even for novices to realize the tide of a difficult shogi game. Non Patent Literature 1 discloses a technique for evaluating the tide of a shogi game.

### CITATION LIST

### Non Patent Literature

{NPL 1}
Yoko Nishihara, Reona Takayama, Kensuke Hishida, and Ryosuke Yamanishi. 2018. Enjoy Watching Japanese Chess Games like Football: an Evaluation Method of Game Positions for Beginners. In Proceedings of the 2018 Annual Symposium on Computer-Human Interaction in Play Companion Extended Abstracts (CHI PLAY '18 Extended Abstracts). Association for Computing Machinery, New York, NY, USA, 569-575, [online], 23 Oct. 2018, [retrieved on 24 Mar. 2022], the Internet <URL: https://dl.acm.org/doi/10.1145/3270316.3271508>

### SUMMARY OF INVENTION

### Technical Problem

The inventor has considered introducing tide evaluation AI into esports so that even novices can intuitively appreciate intricacies in offense and defense tactics in esports, in which tactics are rapidly becoming more sophisticated. With esports, however, unlike shogi, with which the rules are substantially fixed, there is a demand for AI that can adapt to rules and game elements that are updated frequently. The technique disclosed in Non Patent Literature 1 is a technique for evaluating the tide of a shogi game, and it is difficult to apply the technique directly to tide evaluation for esports for reasons including the reason described above.

It is an object of the present invention to provide a novel technique for evaluating the tide of a game.

### Solution to Problem

The present invention, in one aspect thereof, provides a tide evaluation device including:
a reference-data storage unit that stores reference data, the reference data being data generated on the basis of log data of a plurality of game plays executed in the past, and the reference data including a plurality of combinations of reference state information representing a game state in a game play and a game result determined following the game state;
an acquisition unit that acquires subject state information representing a game state at a timing for evaluating a game play to be evaluated;
a search unit that extracts the reference state information similar to the subject state information from among the reference data;
an evaluation unit that evaluates the tide of a game at the timing for evaluating the game play to be evaluated on the basis of the game results associated with the reference state information extracted; and
an output unit that outputs the result of the evaluation.

Furthermore, the present invention, in one aspect thereof, provides a tide evaluation method wherein a computer executes:
storing reference data, the reference data being data generated on the basis of log data of a plurality of game plays executed in the past, and the reference data including a plurality of combinations of reference state information representing a game state in a game play and a game result determined following the game state;
an acquisition step of acquiring subject state information representing a game state at a timing for evaluating a game play to be evaluated;
a search step of extracting the reference state information similar to the subject state information from among the reference data;
an evaluation step of evaluating the tide of a game at the timing for evaluating the game play to be evaluated on the basis of the game results associated with the reference state information extracted; and
an output step of outputting the result of the evaluation.

Furthermore, the present invention, in one aspect thereof, provides a program for causing a computer to function as:
a reference-data storage means for storing reference data, the reference data being data generated on the basis of log data of a plurality of game plays executed in the past, and the reference data including a plurality of combinations of reference state information representing a game state in a game play and a game result determined following the game state;
an acquisition means for acquiring subject state information representing a game state at a timing for evaluating a game play to be evaluated;
a search means for extracting the reference state information similar to the subject state information from among the reference data;
an evaluation means for evaluating the tide of a game at the timing for evaluating the game play to be evaluated on the basis of the game results associated with the reference state information extracted; and
an output means for outputting the result of the evaluation.

### Advantageous Effects of Invention

The present invention, in one aspect thereof, realizes a novel technique for evaluating the tide of a game.

### BRIEF DESCRIPTION OF DRAWINGS

The above-described and other objects, features, and advantages will become further apparent with the following descriptions of suitable embodiments as well as the following accompanying drawings.

FIG. 1 is a diagram showing an example hardware configuration of a tide evaluation device.

FIG. 2 is a diagram showing an example functional block diagram of the tide evaluation device.

FIG. 3 is a schematic illustration of example information that is realized by the tide evaluation device.

FIG. 4 is a flowchart showing an example flow of a process that is performed by the tide evaluation device.

FIG. 5 is a diagram showing another example functional block diagram of the tide evaluation device.

FIG. 6 is an illustration schematically showing an example game board state in an example.

FIG. 7 is a diagram schematically showing an example architecture of the example.

FIG. 8 is a diagram schematically showing the structures of log data and reference data in the example.

FIG. 9 is a figure schematically showing an example vector representing a game state in the example.

### DESCRIPTION OF EMBODIMENTS

Embodiments of the present invention will be described below with reference to the drawings. Note that like signs are attached to like constituent elements throughout the drawings, and descriptions thereof will be omitted as appropriate.

### First Embodiment

### Overview

A tide evaluation device according to this embodiment evaluates the tide of a game at a timing for evaluating a game play to be evaluated on the basis of log data of a plurality of game plays executed in the past.

More specifically, the tide evaluation device stores data generated on the basis of log data of a plurality of game plays executed in the past, where the data that is stored is reference data including a plurality of combinations of reference state information representing a game state during a game play and a game result determined following the game state. That is, the reference data is data in which game states that actually occurred in a plurality of game plays executed in the past are associated with the actual game results that followed such game states.

Furthermore, upon acquiring subject state information representing the game state at a timing for evaluating a game play to be evaluated, the tide evaluation device extracts reference state information similar to the subject state information from among the reference data. Then, the tide evaluation device evaluates the tide of the game at the timing for evaluating the game play to be evaluated on the basis of the game results associated with the reference state information extracted.

### Hardware Configuration

Next, an example hardware configuration of the tide evaluation device will be described. Individual functional units of the tide evaluation device are implemented in the form of an arbitrary combination of hardware and software, mainly including a central processing unit (CPU) and a memory of an arbitrary computer, programs loaded into the memory, a storage unit that stores the programs, such as a hard disk (which can store not only programs stored in advance when the device is shipped but also programs loaded from storage media such as compact discs (CDs) or downloaded from servers on the Internet, etc.), and a network connection interface. Furthermore, it would be understood by a person skilled in the art that there are various modifications concerning the method and device for implementation.

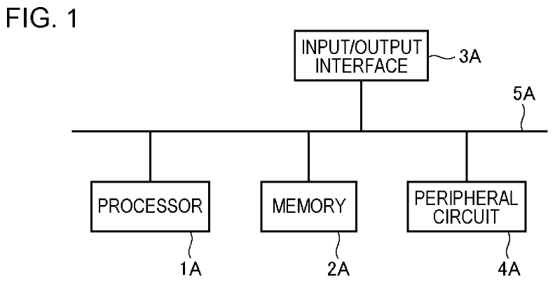

FIG. 1 is a block diagram showing an example hardware configuration of the tide evaluation device. As shown in FIG. 1, the tide evaluation device includes a processor 1A, a memory 2A, input/output interfaces 3A, a peripheral circuit 4A, and a bus 5A. The peripheral circuit 4A includes various modules. The tide evaluation device need not include the peripheral circuit 4A. Note that the tide evaluation device may be constituted of a plurality of physically and/or logically separate devices. In this case, each of the plurality of devices may include the hardware configuration described above.

The bus 5A is a data transmission path for allowing the processor 1A, the memory 2A, the peripheral circuit 4A, and the input/output interfaces 3A to send data to and receive data from each other. The processor 1A is a computational processing device, such as a CPU or a graphics processing unit (GPU). The memory 2A is a memory, such as a random access memory (RAM) or a read only memory (ROM). The input/output interfaces 3A include interfaces such as those for acquiring information from input devices, external devices, external servers, external sensors, cameras, etc. as well as those for outputting information to output devices, external devices, external servers, etc. The input devices are, for example, a keyboard, a mouse, a microphone, physical buttons, and a touch panel. The output devices are, for example, a display, a speaker, a printer, and a mailer. The processor 1A can issue instructions to the individual modules and can perform computations on the basis of the results of computations by the modules.

### Functional Configuration

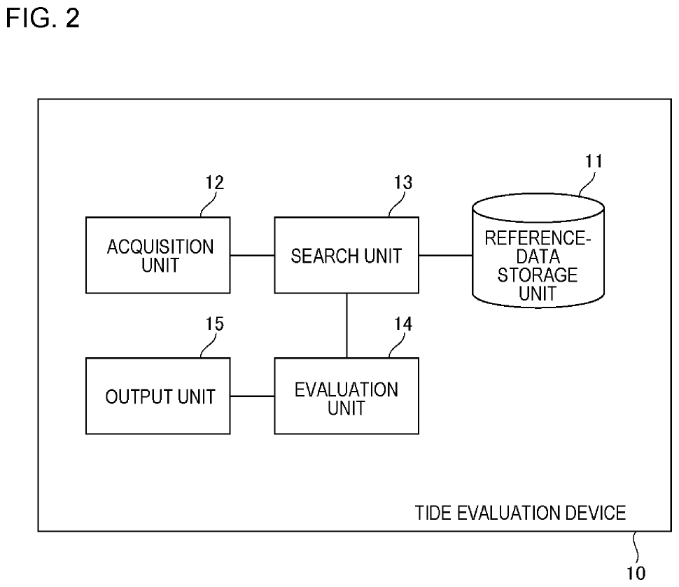

Next, the functional configuration of the tide evaluation device in this embodiment will be described in detail. FIG. 2 shows an example functional block diagram of the tide evaluation device 10 in this embodiment. As shown in FIG. 2, the tide evaluation device 10 includes a reference-data storage unit 11, an acquisition unit 12, a search unit 13, an evaluation unit 14, and an output unit 15.

The reference-data storage unit 11 stores reference data generated on the basis of log data of a plurality of game plays executed in the past. The reference data is data in which game states that actually occurred in a plurality of game plays executed in the past are associated with the actual game results determined following such game states.

“Log data” is data that makes it possible to identify game states during a game play, actions selected by players (operations selected by players) in the game, and a game result determined following the actions. For example, log data is an array including a pair of the first game state and the first action, followed by a series of pairs of a game state resulting from the effect of a preceding action and the next action, and terminated with a final state in which the outcome was finally determined.

A “game state” is a state that can be acquired from a game and is identified in terms of the value of at least one parameter that may affect the result of the game. Hereinafter, parameters for identifying a game state will be referred to as game-state identifying parameters. The values of game-state identifying parameters may change as the game proceeds. Various parameters may be adopted as game-state identifying parameters, and game-state identifying parameters may be determined in accordance with the type, content, etc. of the game.

For example, in the case of a PVP card game, examples of game-state identifying parameters include, but are not limited to, information concerning cards on the board, the number of cards in the hand, the number of cards discarded, the physical energy of each player, various kinds of points (points consumed in order to place cards in the field, points consumed in order to evolve cards, etc.), the number of turns, and leader character information. Note that although the description has been given here in the context of a PVP card game, the types of games applicable in this invention are not limited thereto.

The values of game-state identifying parameters may be expressed in the form of numerical values, variable names, etc. in the game. In the reference data, the numerical values or variable names used in the game may be used as they are for the values of the individual game-state identifying parameters. However, for reasons including the benefit of the ease of searching by the search unit 13, which will be described later, as the values of game-state identifying parameters in the reference data, it is preferable to use values encoded into a vector while normalizing the numerical values or variable names used in the game according to prescribed rules (e.g., 0 to 1). This makes it possible to quantitatively measure the degree of similarity between specific game states in the form of the degree of similarity between vectors.

An “action selected by a player (operation selected by a player) in the game” is an action selected as a result of an input by a player in the game. For example, in the case of a PvP card game, an example of such an action is the use of a card (the kind of card used is also indicated).

A “game result” is defined in accordance with the type, content, etc. of the game. For example, in the case of a PVP card game, game results may include “win for the first player” and “win for the second player”. Furthermore, in the case of a game for which a “draw” is a possible result, game results may include “draw”. Furthermore, in the case of a game with which the competition is based on scores, game results may include “win for the first player by P or more points”, “win for the first player by points less than P”, “win for the second player by P or more points”, and “win for the second player by points less than P”.

The acquisition unit 12 acquires the subject state information representing a game state at a timing for evaluating a game play to be evaluated. In the subject state information, the game state is expressed in terms of the values of game-state identifying parameters, similarly to reference data.

The acquisition unit 12 can acquire various kinds of information, such as the subject state information, from an online game server and player terminals (personal computers, smartphones, tablet terminals, mobile phones, game terminals, etc.). While the game is being executed, the acquisition unit 12 can acquire the subject state information periodically per certain time.

The search unit 13 extracts reference state information similar to the subject state information acquired by the acquisition unit 12 from among the reference data stored in the reference-data storage unit 11. The search unit 13 can realize the abovementioned extraction by way of nearest neighbor search or approximate nearest neighbor search.

For example, reference data are grouped on the basis of game play characteristics. That is, reference data with which game play characteristics coincide or are similar by at least a prescribed level are aggregated into a group. Then, the reference-data storage unit 11 stores reference data on a per-group basis. Various game play characteristics may be used for grouping, and the choice may be determined in accordance with the type, content, etc. of the game. For example, in the case of a PvP card game, the characters selected by the players may be adopted. Alternatively, the values of game parameters, such as the number of turns, may be used as the game play characteristics mentioned above. Alternatively, player characteristics (game skill level (advanced, intermediate, or novice), sex, nationality, age group, number of years played, etc.) may be used as the game play characteristics mentioned above. Furthermore, the search unit 13 identifies a group to which the game play to be evaluated belongs on the basis of the characteristics of the game play to be evaluated (or the characteristics of the game play to be evaluated at the timing of evaluation) and extracts reference state information similar to the subject state information from among the reference data that belong to the identified group. Specific examples of the above-described configuration will be described in the context of the embodiments below.

The evaluation unit 14 evaluates the tide of the game at the timing for evaluating the game play to be evaluated on the basis of the game results associated with the reference state information extracted by the search unit 13. On the basis of the game results associated with the reference state information extracted by the search unit 13, the evaluation unit 14 calculates the probability that the result of evaluating the game play being evaluated becomes each of the plurality of game results defined as described earlier (“win for the first player”, “win for the second player”, etc.).

Specifically, as the above-mentioned probability of each of the plurality of game results, the evaluation unit 14 calculates the ratio by which the same game result is included among the plurality of game results associated with the plurality of items of reference state information extracted by the search unit 13. For example, in the case where M₁ items of reference state information are extracted by the search unit 13, and M₂ items thereamong are associated with the game result “win for the first player”, the evaluation unit 14 calculates M₂/M₁ as the probability of a win for the first player.

Note that the evaluation unit 14 may include a means for correcting the calculated probability mentioned above. For example, the evaluation unit 14 may correct the calculated probability mentioned above on the basis of the degrees of similarity between the set of the plurality of items of reference state information extracted by the search unit 13 and the subject state information. The evaluation unit 14 performs correction such that the abovementioned probability after the correction processing becomes higher as the degree of similarity becomes higher. For example, the correction processing may be performed according to the rule that “correction is not to be performed in the case where the degree of similarity is greater than or equal to a reference value, and the calculated probability mentioned above is to be decreased in the case where the degree of similarity is less than the reference value”. The width of decrease may be set in accordance with the degree of disparity between the degree of similarity and the reference value. The abovementioned correction rule is merely an example, and there is no limitation thereto.

“The degree of similarity between the set of the plurality of items of reference state information extracted by the search unit 13 and the subject state information” may be, for example, a statistical value (the mean, the maximum value, the minimum value, the mode, the median, or the like) between each of the plurality of items of reference state information extracted by the search unit 13 and the subject state information, or may be calculated by other means.

As another example means for correcting the calculated probability mentioned above, the evaluation unit 14 may correct the calculated probability mentioned above on the basis of the disparity between the current timing and the timing of execution of the game play from which each of the plurality of items of reference state information extracted by the search unit 13 was derived. The evaluation unit 14 performs correction such that the abovementioned probability after the correction processing becomes higher as the disparity becomes smaller. For example, the correction processing may be performed according to the rule that “correction is not to be performed in the case where the disparity mentioned above is less than a reference value, and the calculated probability mentioned above is to be decreased in the case where the disparity mentioned above is greater than or equal to the reference value”. The width of decrease may be set in accordance with the magnitude of the difference between the abovementioned disparity and the reference value. Note that the abovementioned correction rule is merely an example, and there is no limitation thereto.

“The timing of execution of the game play from which each of the plurality of items of reference state information extracted by the search unit 13 was derived” may be a statistical value (the oldest timing, the latest timing, the mode, the median, or the like) concerning the timings (dates and times) of execution of the game plays from which the individual items of reference state information extracted by the search unit 13 were derived.

The evaluation unit 14 can evaluate the tide of the game by measuring (through statistical processing, correction, etc.) the game results associated with the reference state information extracted by the search unit 13.

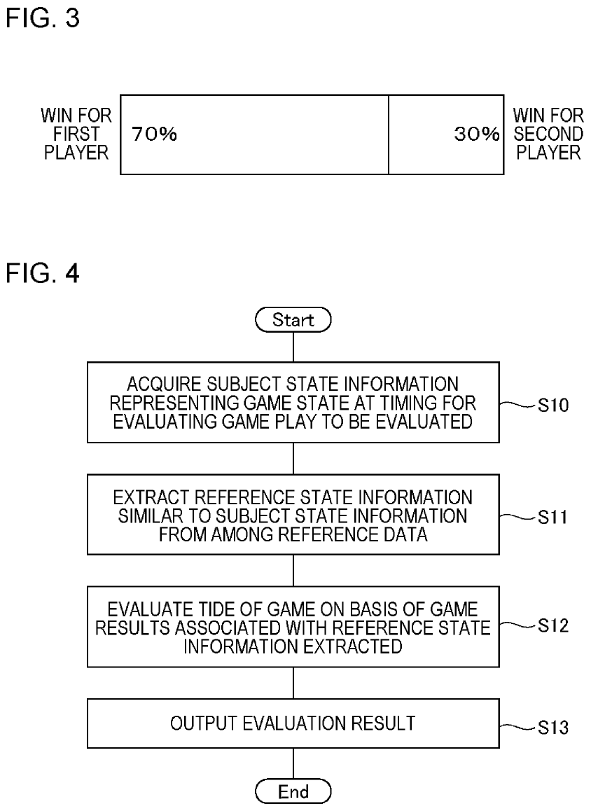

The output unit 15 outputs the result of evaluation of the tide of the game by the evaluation unit 14. For example, the result of evaluation of the tide of the game, output from the output unit 15, may be input to the game server. Furthermore, the result of evaluation of the tide of the game may be displayed on the game screen of the game play evaluated. Alternatively, the result of evaluation of the tide of the game, output from the output unit 15, may be input to a system that generates a screen for viewers of the game. Furthermore, the result of evaluation of the tide of the game may be displayed on the screen for viewers of the game. FIG. 3 shows an example of the result of evaluation of the tide of the game, displayed on the game screen or the screen for viewers of the game. In the example shown in FIG. 3, the game result is “win for the first player” or “win for the second player”, and the probabilities of the individual game results are shown as the result of evaluation of the tide of the game.

Note that the tide evaluation device 10 having the functions described above may be implemented on a game server. That is, the game server and the tide evaluation device 10 may be configured to be physically and/or logically integrated. Alternatively, the tide evaluation device 10 may be implemented on each player terminal. That is, each player terminal and the tide evaluation device 10 may be configured to be physically and/or logically integrated. Alternatively, the tide evaluation device 10 may be an independent device that is physically and/or logically separate from the game server and player terminals.

Next, an example flow of a process that is executed by the tide evaluation device 10 will be described with reference to a flowchart in FIG. 4. The following process is a process for evaluating the tide of a game at a timing for evaluating a game play to be evaluated. Prior to the processing, reference data is stored in advance in the reference-data storage unit 11, the reference data being data generated on the basis of log data of a plurality of game plays executed in the past and including a plurality of combinations of reference state information representing a game state during a game play and a game result determined following the game state.

First, the acquisition unit 12 acquires subject state information representing the game state at a timing for evaluating a game play to be evaluated (S10). Then, the search unit 13 extracts reference state information similar to the subject state information acquired in S10 from among the reference data stored in the reference-data storage unit 11 (S11). Then, the evaluation unit 14 evaluates the tide of the game at the timing for evaluating the game play to be evaluated on the basis of the game results associated with the reference state information extracted in S11 (S12). Then, the output unit 15 outputs the result of evaluation calculated in S12, i.e., information indicating the tide of the game at the timing for evaluating the game play evaluated (S13).

The tide evaluation device 10 can execute the above-described process repeatedly during the execution of the game play being evaluated.

### Operations and Advantages

With the tide evaluation device 10 in this embodiment, it is possible to evaluate the tide of a game at a timing for evaluating a game play to be evaluated on the basis of game states that may occur during the game play and records of game results that followed such game states. This makes it possible to evaluate the tide of a game without having to take rules and game elements of the game into consideration. Accordingly, it is possible to evaluate the tide of a game by using the above-described technique even if rules or game elements are frequently updated in the game.

Furthermore, it will be understood that the tide evaluation device 10 calculates the probabilities of individual game results following such states on the basis of past log data and outputs the probabilities as the result of evaluation of the tide of the game. This makes it possible to output an evaluation result that is readily understandable for and readily convincing to viewers.

### Second Embodiment

In a second embodiment, the configuration of the tide evaluation device 10, specifically, the configuration of a reference-data database, as well as processing for searching the database, are embodied.

Even with game states that are similar to each other, the game results that follow may mutually vary depending on the timings thereof, e.g., whether the game states belong to the opening phase, the middlegame phase, or the endgame phase of a game. The tide evaluation device 10 in the second embodiment is configured to be able to evaluate the tide of a game while taking this point into consideration.

The game in the second embodiment is a PVP game in which the first player and the second player alternately perform actions. An example thereof is a PVP card game.

Furthermore, in the second embodiment, reference data are grouped on the basis of the number of actions as counted beginning from the first action (referred to as “the number of turns” in some cases). That is, the reference-data storage unit 11 groups a plurality of items of reference data on the basis of the number of actions as counted beginning from the first action and stores the reference data as classified into individual groups.

For example, groups may be formed per number of actions. In this case, a group corresponding to the number of actions of one, a group corresponding to the number of actions of two, etc. are formed. Alternatively, groups may be formed per a plurality of numbers of actions. For example, a prescribed number of successive numbers of actions may be aggregated to form a single group. In this case, a group corresponding to the numbers of actions of one to three, a group corresponding to the numbers of actions of four to six, etc. are formed.

The acquisition unit 12 further acquires the number of actions at the timing for evaluating the game play to be evaluated. Then, the search unit 13 extracts reference state information similar to the subject state information from among the reference data that belong to the group corresponding to the number of actions at the timing for evaluating the game play to be evaluated.

Alternatively, the search unit 13 may extract reference state information similar to the subject state information from among reference data that belong to one or more groups individually corresponding to the numbers of actions included in the range of (the number of actions at the timing for evaluating the game to be evaluated−α) to (the number of actions at the timing for evaluating the game to be evaluated+α). α is a positive integer, and the specific value thereof, which is a design matter, may be, for example, about three to five. With game states similar to each other, even if the numbers of actions slightly vary, it is often the case that similar game results follow. By searching reference data that belong to a plurality of groups, as described above, as well as the group corresponding to the number of actions at the timing for evaluating the game to be evaluated, it is possible to increase the number of items of reference data that are extracted. As a result, it is possible to obtain a more reliable result of evaluation of the tide of the game.

The tide evaluation device 10 in the second embodiment is otherwise configured the same as the tide evaluation device 10 in the first embodiment.

With the tide evaluation device 10 in the second embodiment, operations and advantages similar to those of the tide evaluation device 10 in the first embodiment are realized. Furthermore, with the tide evaluation device 10 in the second embodiment, it is possible to evaluate the tide of a game at a timing for evaluating a game play to be evaluated on the basis of past records of game results that followed game states similar to a game state in the game play to be evaluated with number of actions similar to the number of actions at the timing for evaluating the game play to be evaluated.

Even with game states that are similar to each other, the game results that follow may mutually vary depending on the timings thereof, e.g., whether the game states belong to the opening phase, the middlegame phase, or the endgame phase of a game. With the tide evaluation device 10 in the second embodiment described above, it is possible to evaluate the tide of a game while taking into consideration the timing of a game play to be evaluated at a timing for evaluation. This makes it possible to perform more reliable evaluation. Furthermore, since it is possible to narrow down reference data to be searched on the basis of the number of actions, the burden of processing for a computer is reduced.

### Third Embodiment

In a third embodiment, the configuration of the tide evaluation device 10, specifically, the configuration of a reference-data database, as well as processing for searching the database, are embodied.

Even with game states that are similar to each other, the game results that follow may mutually vary depending on the characters selected by players. The tide evaluation device 10 in the third embodiment is configured to be able to evaluate the tide of a game while taking this point into consideration.

The game in the third embodiment is a game in which the first player and the second player each select a character. An example thereof is a PVP card game. Note that the term “characters” may vary among individual games. “Characters” in the third embodiment include the concepts of, for example, characters, classes, and attributes.

Furthermore, in the third embodiment, reference data are grouped on the basis of the combination of the character selected by the first player and the character selected by the second player. That is, the reference-data storage unit 11 groups a plurality of items of reference data on the basis of each combination of the character selected by the first player and the character selected by the second player, and stores the reference data as classified into individual groups. For example, the reference-data storage unit 11 stores reference data for individual combinations of the characters selected by the first player and the second player, like “reference data for the case where the first player selected character A and the second player selected character B” and “reference data for the case where the first player selected character A and the second player selected character C”.

The acquisition unit 12 further acquires information representing the character selected by the first player and the character selected by the second player in the game play to be evaluated. Then, the search unit 13 extracts reference state information similar to the subject state information from among the reference data that belong to the group corresponding to the combination of the character selected by the first player and the character selected by the second player in the game play to be evaluated.

Note that the tide evaluation device 10 in the third embodiment may include the configuration of the tide evaluation device 10 in the second embodiment. In this case, reference data are grouped on the basis of the number of actions as counted beginning from the first action as well as the combination of the character selected by the first player and the character selected by the second player. That is, the reference-data storage unit 11 groups a plurality of items of reference data on the basis of the number of actions as counted beginning from the first action and the combination of the character selected by the first player and the character selected by the second player, and stores the reference data as classified into individual groups.

Then, the search unit 13 extracts reference state information similar to the subject state information from the reference data that belong to the group corresponding to the combination of the character selected by the first player and the character selected by the second player in the game play to be evaluated and also corresponding to the number of actions at the timing for evaluation.

The tide evaluation device 10 in the third embodiment is otherwise configured the same as the tide evaluation devices 10 in the first and second embodiments.

With the tide evaluation device 10 in the third embodiment, operations and advantages similar to those of the tide evaluation devices 10 in the first and second embodiments are realized. Furthermore, with the tide evaluation device 10 in the third embodiment, it is possible to evaluate the tide of a game at a timing for evaluating a game play to be evaluated on the basis of past records of game results that followed game states similar to a game state in the game play to be evaluated under situations in which the first player and the second player selected the same characters as in the game play to be evaluated.

Even with game states that are similar to each other, the game results that follow may mutually vary depending on the characters selected by the first player and the second player. With the tide evaluation device 10 in the third embodiment described above, it is possible to evaluate the tide of a game while taking into consideration the characters selected by the first player and the second player in a game play to be evaluated. This makes it possible to perform more reliable evaluation. Furthermore, since it is possible to narrow down reference data to be searched on the basis of the characters selected by the first player and the second player, the burden of processing for a computer is reduced. Furthermore, by further adopting the configuration of the tide evaluation device 10 in the second embodiment, it is possible to perform more reliable evaluation, and the burden of processing for a computer is further reduced.

### Fourth Embodiment

In a fourth embodiment, the configuration of the tide evaluation device 10, specifically, the configuration of a reference-data database, as well as processing for searching the database, are embodied.

Even with game states that are similar to each other, the game results that follow may mutually vary depending on player characteristics. The tide evaluation device 10 in the fourth embodiment is configured to be able to evaluate the tide of a game while taking this point into consideration.

In the fourth embodiment, reference data is grouped on the basis of the combination of the player characteristics of the first player and the player characteristics of the second player. That is, the reference-data storage unit 11 groups a plurality of items of reference data in accordance with the combination of the player characteristics of the first player and the player characteristics of the second player, and stores the reference data as classified into individual groups. The player characteristics are the game skill level (advanced, intermediate, or novice), sex, nationality, age group, number of years played, etc. For example, the reference-data storage unit 11 stores reference data for individual combinations of the player characteristics of the first player and the second player, like “reference data in the case where the first player and the second player were advanced players” and “reference data in the case where the first player was an advanced player and the second player was an intermediate player”.

The acquisition unit 12 acquires the player characteristics of the first player and the second player in the game play to be evaluated. For example, the individual player characteristics of a plurality of players may be registered in advance in the game server. Then, the acquisition unit 12 may acquire the player characteristics of the first player and the player characteristics of the second player in the game play to be evaluated from the game server.

Then, the search unit 13 extracts the reference state information similar to the subject state information from among the reference data that belong to the group corresponding to the combination of the player characteristics of the first player and the player characteristics of the second player in the game play to be evaluated.

Note that the tide evaluation device 10 in the fourth embodiment may include the configuration of the tide evaluation device 10 in the second embodiment. In this case, reference data are grouped on the basis of the number of actions as counted beginning from the first action as well as the combination of the player characteristics of the first player and the player characteristics of the second player. That is, the reference-data storage unit 11 groups a plurality of items of reference data in accordance with the number of actions as counted beginning from the first action as well as the combination of the player characteristics of the first player and the player characteristics of the second player, and stores the reference data as classified into individual groups.

Then, the search unit 13 extracts reference state information similar to the subject state information from among the reference data that belong to the group corresponding to the combination of the player characteristics of the first player and the player characteristics of the second player in the game play to be evaluated and also corresponding to the number of actions at the timing for evaluation.

Alternatively, the tide evaluation device 10 in the fourth embodiment may include the configuration of the tide evaluation device 10 in the third embodiment. In this case, reference data are grouped on the basis of the combination of the character selected by the first player and the character selected by the second player as well as the combination of the player characteristics of the first player and the player characteristics of the second player. That is, the reference-data storage unit 11 groups a plurality of items of reference data in accordance with the combination of the character selected by the first player and the character selected by the second player as well as the combination of the player characteristics of the first player and the player characteristics of the second player, and stores the reference data as classified into individual groups.

Then, the search unit 13 extracts reference state information similar to the subject state information from among the reference data that belong to the group corresponding to the combination of the character selected by the first player and the character selected by the second player in the game play to be evaluated and also corresponding to the combination of the player characteristics of the first player and the player characteristics of the second player in the game play to be evaluated.

Alternatively, the tide evaluation device 10 may include the configurations of the tide evaluation devices 10 in the second and third embodiments. In this case, reference data are grouped on the basis of the number of actions as counted beginning from the first action, the combination of the character selected by the first player and the character selected by the second player, and the combination of the player characteristics of the first player and the player characteristics of the second player. That is, the reference-data storage unit 11 groups a plurality of items of reference data in accordance with the number of actions as counted beginning from the first action, the combination of the character selected by the first player and the character selected by the second player, and the combination of the player characteristics of the first player and the player characteristics of the second player, and stores the reference data as classified into individual groups.

Then, the search unit 13 extracts reference state information similar to the subject state information from among the reference data that belong to the group corresponding to the combination of the character selected by the first player and the character selected by the second player in the game play to be evaluated, corresponding to the combination of the player characteristics of the first player and the player characteristics of the second player in the game play to be evaluated, and also corresponding to the number of actions at the timing for evaluation.

The tide evaluation device 10 in the fourth embodiment is otherwise configured the same as the tide evaluation devices 10 in the first to third embodiments.

With the tide evaluation device 10 in the fourth embodiment, operations and advantages similar to those of the tide evaluation devices 10 in the first to third embodiments are realized. Furthermore, with the tide evaluation device 10 in the fourth embodiment, it is possible to evaluate the tide of a game at a timing for evaluating a game play to be evaluated on the basis of past records of game results that followed game states similar to a game state in the game play to be evaluated in game plays performed by first players and second players having the same player characteristics as in the game play to be evaluated.

Even with game states that are similar to each other, the game results that follow may mutually vary depending on the player characteristics of the first player and the second player. With the tide evaluation device 10 in the fourth embodiment described above, it is possible to evaluate the tide of a game while taking into consideration the player characteristics of the first player and the second player in a game play to be evaluated. This makes it possible to perform more reliable evaluation. Furthermore, since it is possible to narrow down reference data to be searched on the basis of the player characteristics of the first player and the second player, the burden of processing for a computer is reduced. Furthermore, by further adopting the configuration of at least one of the tide evaluation devices 10 in the second and third embodiments, it is possible to perform more reliable evaluation, and the burden of processing for a computer is further reduced.

### Fifth Embodiment

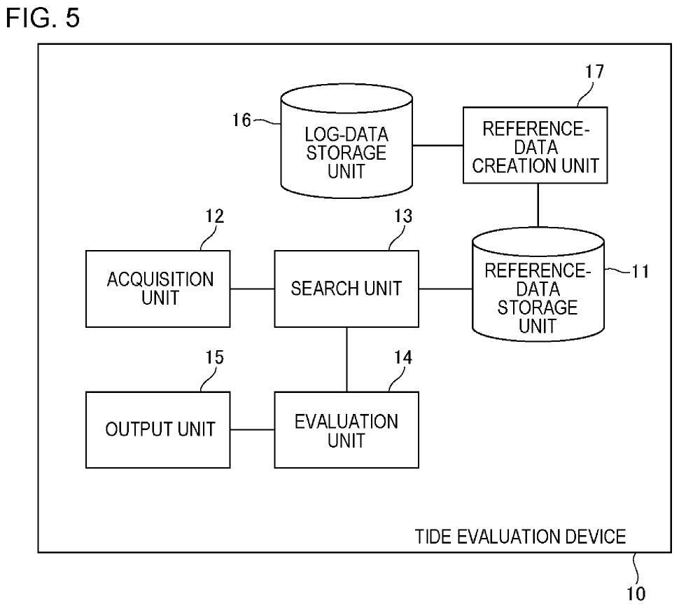

The tide evaluation device 10 in this embodiment further has a function for creating the reference data described above. FIG. 5 shows an example functional block diagram of the tide evaluation device 10 in the fifth embodiment. As shown in FIG. 5, the tide evaluation device 10 differs from the first to fourth embodiments in further including a log-data storage unit 16 and a reference-data creation unit 17.

The log-data storage unit 16 stores log data of a plurality of game plays executed in the past. The log data is stored in association with various kinds of attribute information. Examples of the attribute information include the player characteristics described above as well as the dates and times of the execution of plays.

The reference-data creation unit 17 creates the reference data described in the context of the first to fourth embodiments on the basis of the log data stored in the log-data storage unit 16, and stores the reference data in the reference-data storage unit 11.

Note that the reference-data creation unit 17 may extract prescribed log data from among the log data stored in the log-data storage unit 16 and may create reference data on the basis of the log data extracted. In this case, the log data not extracted are not used in creating reference data.

For example, the reference-data creation unit 17 may extract log data of game plays executed in the past by players having player characteristics that satisfy a prescribed condition. The prescribed condition is, for example, the condition that the skill level is not lower than a prescribed level (e.g., an advanced player).

Alternatively, the reference-data creation unit 17 may extract log data with which the date and time of play execution is later than a prescribed date and time (i.e., is relatively new).

The tide evaluation device 10 in the fifth embodiment is otherwise configured the same as the tide evaluation devices 10 in the first to fourth embodiments.

With the tide evaluation device 10 in the fifth embodiment, operations and advantages similar to those of the tide evaluation devices 10 in the first to fourth embodiments are realized. Furthermore, with the tide evaluation device 10 in the fifth embodiment, it is possible to extract only prescribed log data from among log data and to create reference data on the basis of the log data extracted.

For example, with the tide evaluation device 10 in the fifth embodiment, it is possible to extract only log data of players with high skill levels and to create reference data on the basis of the log data extracted. In the case where the skill levels of players are low, actions that are performed by the players following certain game states may vary considerably. As a result, the game results that follow such game states may also vary considerably. The reliability of evaluation results becomes low if reference data are created without distinguishing such log data of players with low skill levels from log data of players with high skill levels and the tide of a game is evaluated accordingly. Furthermore, it is presumable that game viewers want the result of evaluating the tide of a game as viewed from the viewpoints of advanced players.

By extracting only log data of players with high skill levels and creating reference data on the basis of the log data extracted, it is possible to create evaluation results that are reliable and that better fit the needs of viewers (the results of evaluation of the tide of a game as viewed from the viewpoints of advanced players). Furthermore, it is possible to naturally and reasonably realize such behavior as to “present an outcome with a confidence as high as about 90% for a board state in great favor of one player when judged by players with high skill levels though judged otherwise by novices, while presenting an outcome with a confidence as low as about 50% for a board state in which it is difficult even for players with high skill levels to predict the outcome, like a board state in the opening phase or in the middlegame phase”.

Alternatively, with the tide evaluation device 10 in the fifth embodiment, it is possible to extract only log data with which the date and time of play execution is later than a prescribed date and time (i.e., is relatively new) and to create reference data on the basis of the log data extracted. With the elapse of time, new game tactics are developed, and the manners of play also change. Thus, situations may arise in which the probability that a certain game state is followed by a certain game result was high in the past but that is recently not necessarily the case.

By extracting only relatively new log data and creating reference data on the basis of the log data extracted, it is possible to create reliable evaluation results.

### Example

### Overview

In this example, AI (the tide evaluation device 10) evaluates the tide of a PVP game through approximate nearest neighbor search in which processes of changes in the board state (game state) are associated with the outcomes (game results), while considering the game environment as a black box. A technical feature of this example is that, when predicting the outcome from a specific board state, situations similar to that board state are retrieved from past data classified on the basis of the combination of contending characters as well as the number of actions as counted beginning from the first action, and the win/loss probabilities are calculated from the outcomes associated with the similar situations. Accordingly, it is possible to perform learning just with pairs of a middle-of-play board state and an outcome without the system having to learn game rules or the environment, i.e., while considering the game system as a black box, which allows application to a wide range of PVP games.

Specifically, in this example, for all the log data of game plays that are subject to learning, the individual board states constituting the log data are converted into feature vectors having thousands of dimensions, and the feature vectors are classified on the basis of the combination of contending characters as well as the number of actions as counted beginning from the first action to construct databases for approximate nearest neighbor search. For example, in the case of a game that includes eight kinds of characters and that ends in thirty actions on average, 8×8×30=1920 databases are constructed. This is equivalent to creating 1920 groups in the context of the embodiments described above.

When the game is executed, i.e., with a situation for which the tide is to be evaluated, assuming that the cards present on the screen in the situation as well as parameter information for the situation are expressed by a feature vector q, in this example, approximate nearest neighbor (ANN) search for the feature vector q of the current situation is performed by using the databases associated with the same combination of characters as in the situation and also associated with the numbers of actions included in the range of (the same number of actions as in the situation+N) to (the same number of actions as in the situation−N), thereby obtaining a set of data for similar situations. The win-loss ratio in this set is considered as the win/loss probabilities in the situation subject to inference. This makes it possible to derive an evaluation score based on evidence that “M out of N players won after this type of situation”.

### Method of Implementation

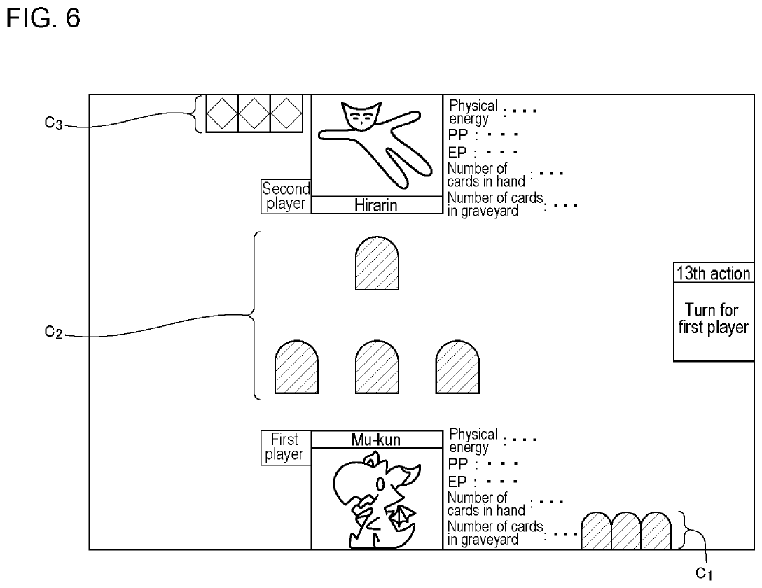

The essence of this example is to “predict the outcome resulting from the current board state from the outcomes associated with past board states similar to the current board state”. Specifically, the system encodes a board status in a game, such as the one shown in FIG. 6, in the form of a multi-dimensional vector in which the values of the individual dimensions are normalized to a range of zero to one, and retrieves past board states similar to the multi-dimensional vector at high speed. FIG. 6 shows characters selected by individual players, the values of various kinds of parameters, the number of actions, cards C₁ and C₃ possessed by the individual players, cards C₂ placed in the field, etc.

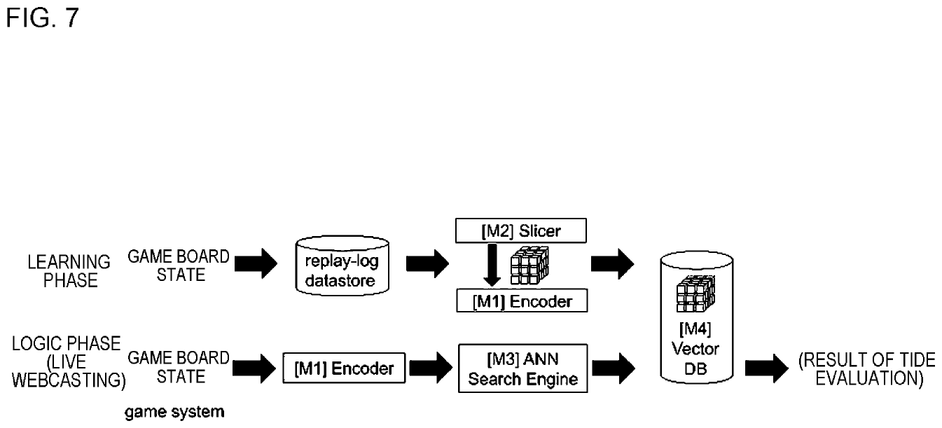

FIG. 7 shows an architecture for realizing this system. In this example, the outcome is predicted by using only similarity in board states, without having to employ complex machine learning or deep learning for the purpose of predicting the outcome. This makes it possible to construct vector databases in real time from log data that are accumulated as a game is run normally.

A core feature of this example is the cooperation between module M1 and module M2. [M2] Slicer extracts the board state (see FIG. 6) that changes continuously in the course of a single PvP battle, while considering each board state as instantaneous replay information. From the instantaneous board states extracted, as data representing a game status, [M1] Encoder encodes information that is open to both players, such as information concerning cards on the board, the number of cards in the hand, the number of cards discarded, the physical energy of each player, various kinds of points (points that are consumed in order to place cards in the field, points that are consumed in order to evolve cards, etc.), the number of turns, and leader character information, in the form of a multi-dimensional vector in which the values of the individual dimensions are normalized to a range of zero to one. This makes it possible to quantitatively measure the degree of similarity between specific board states in the form of the degree of similarity between vectors.

### Data Structure

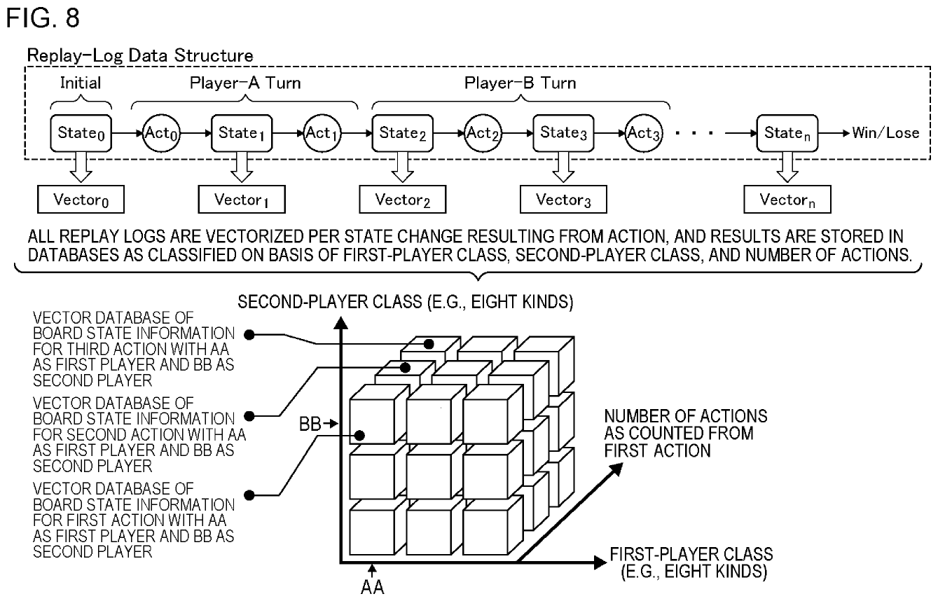

Two basic data structures are adopted in this example: namely, log data that are generated within the game system; and vector data that are stored in databases for approximate nearest neighbor search. In this example, as shown in FIG. 8, log data can be defined in the form of a sequence of tree-structured text representing board states (e.g., a data format called JSON may be adopted) and actions executed by players in the board states. That is, log data is an array including the pair of an initial state and the first action, followed by pairs each consisting of a state resulting from the effect of an action and the next action, and terminated with a final state, in which the final result was determined. Math 1 shows an example of the log data array.

$$\begin{matrix}\{ Math 1 \} & \\ {Replaylog}_{n} := [ {State}_{0} , {Action}_{0} , {State}_{1} , … , Win\_Lose ] & ( Math 1 )\end{matrix}$$

Here, Stateᵢ signifies the i-th game state, Actionᵢ signifies the i-th action executed, and Win Lose signifies a game result (a state in which a win or loss, a draw, a no contest, or the like was determined). Stateᵢ, most simply put, is a set of cards on the board and in the decks, and can be defined as expressed in Math 2.

$$\begin{matrix}\{ Math 2 \} & \\ {State}_{i} := [ {card}_{0}^{sp 1} , {card}_{0}^{sp 2} , {card}_{0}^{dp 1} , {card}_{0}^{dp 2} … , {card}_{n}^{dp 2} ] & ( Math 2 )\end{matrix}$$

Here, card^{sp1}₀ signifies the zeroth card of player 1 (the first player), placed in the field, and card^{sp2}₀ signifies the zeroth card of player 2 (the second player), placed in the field. Furthermore, card^{dp1}₀ signifies the zeroth card of player 1 (the first player), included in the hand, and card^{dp2}₀ signifies the zeroth card of player 2 (the second player), included in the hand.

Next, the database for approximate nearest neighbor search can be defined as expressed in Math 3.

$$\begin{matrix}\{ Math 3 \} & \\ DB := [ db 1 , db 2 , db 3 , … dbx ] & ( Math 3 )\end{matrix}$$

Here, the individual elements db1, db2, db3, . . . , and dbx signify sub-databases that are generated for the individual combinations of a first-player class, a second-player class, and the number of actions as counted beginning from the first action. For example, a sub-database is constructed for “AA as the first player, BB as the second player, and the eighth action” or “AA as the first player, CC as the second player, and the first action”. That is, in the case of a game in which eight kinds of characters exist and in which a battle ends in thirty actions on average, 8×8×30=1920 sub-databases are constructed. The individual sub-databases are independent of each other, and thus an operation for updating a specific sub-database does not affect the other sub-databases at all.

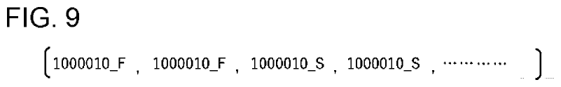

### Primitive Functions

[M1] Encoder is a module that converts a board state at a specific instant into a vector having about 4,000 dimensions. For example, in the case of a PVP card game, this module encodes information that is open to both players, such as information concerning cards on the board, the number of cards in the hand, the number of cards discarded, the physical energy of each player, various kinds of points (points that are consumed in order to place cards in the field, points that are consumed in order to evolve cards, etc.), the number of turns, and leader character information, in the form of a multi-dimensional vector in which the values of the individual dimensions are normalized to a range of zero to one. For the purpose of encoding cards while distinguishing the first player and the second player at this time, in the case where each of the first player and the second player has placed one card with the ID 1000030 in the field, the value of 1000030 first can be expressed as 0.33, and the value of 1000030 second can be expressed as 0.33. FIG. 9 shows an example of this vector. In the data shown in FIG. 9, multi-dimensional vectors generated by [M1] Encoder are arrayed. In the figure, as an example, a vector representing cards of the first player and the second player is shown. The letter “F” corresponding to the first player and the letter “S” corresponding to the second player make it possible to distinguish information concerning the first player and the second player.

Furthermore, as an extension of [M1] Encoder, compatible cards may be associated individually, and values may also be set to the compatible cards in a situation where a specific card is present on the board, which makes it possible to use a new card for a query to search past board states that do not include the new card.

For example, in the case where vectors having 4,000 dimensions corresponding to 1,000 existing cards are used in the system, when two new cards not included at all in those dimensions are added, it is possible to embed the new cards into the vectors having 4,000 dimensions by using a transformation matrix that defines relationships between the two cards and the 1,000 existing cards. Specifically, in the case where a new card A is a kind of card that can function as both ID: 1000030 and ID: 1000050, it is possible to map the new card A into an existing vector according to relational information such as that shown in Table 1, in which positive values such as 1.0 and 0.6 are assigned to the dimensions of ID: 1000030 and ID: 1000050. Furthermore, in the case where a new card B is a variant of ID: 1000040, 1.0 is assigned only to ID: 1000040, as in Table 1. In the case where past board states are to be searched on the basis of a board state including the new cards, it becomes possible to substantially search for similar situations by mapping the new cards to cards in the past by using the matrix (relational information).

TABLE 1

| | 1000030 | 1000040 | 1000050 | . . . |
|---|---|---|---|---|
| New card A | 1.0 | 0 | 0.6 | 0 |
| New card B | 0 | 1.0 | 0 | 0 |

That is, under the situation where “a game state in a game play is expressed in the form of a multi-dimensional vector”, “reference state information and subject state information include a multi-dimensional vector”, and “a vector relating to objects used in a game are included in the multi-dimensional vector”, in the case where the multi-dimensional vector included in the subject state information includes a vector relating to a new object (the “new card” mentioned above), the search unit 13, described above in the context of the embodiments, can transform a vector relating to the new object in the multi-dimensional vector into a vector relating to another object different from the new object by using prescribed transformation information (relational information such as that in Table 1), and can extract reference state information similar to the subject state information by using the transformed multi-dimensional vector.

[M2] Slicer is a module that converts log data into a set of items of instantaneous board state information. Generally, log data are implemented as histories having recorded therein actions adopted by players, the game system acting as the game administrator, and NPCs (these will be collectively referred to as actors), as well as random numbers used when the actions were adopted, and “information concerning the field” is not saved. This is because it suffices to be able to fully reproduce actions of actors in order to ensure that the same field can be reproduced. However, log data in the form of sequences of actions of actors are not necessarily suitable for machine learning as they are. Thus, in this example, log data are actually reproduced on the game system, and the resulting individual items of instantaneous board state information are extracted. The board state information extracted here is information that is unique to the game system, and for example, in the case of a game implemented with the Unity game engine, the board state information is represented as objects in C# language.

[M3] ANN Search Engine is a module that searches a huge number of board state vectors (reference data) for vectors similar to a specific board state. In this example, [M1] Slicer generates an extremely huge number of vectors. Specifically, assuming the case where a single battle ends in about eight turns on average, and five state changes occur due to actions of the first player and five stage changes also occur due to actions of the second player in a single turn, [M2] Slicer generates eighty vectors per battle. Furthermore, when one million battles are played in one day, 80 million vectors are generated in that day. As a technique for retrieving vectors similar to a specific vector at high speed from among such a large number of vectors, the technique called approximate nearest neighbor search (ANN) is used in this example. With ANN, as expressed in Math 4, when a vector q representing a specific situation as well as N sub-databases associated with the same first-player class and second-player class as q and associated with the numbers of actions preceding and succeeding the number of actions of q by a prescribed number are given, k vectors that are similar to q are obtained from the N sub-databases.

$$\begin{matrix}\{ Math 4 \} & \\ ann ( q , db 1 , db 2 , … dbn ) \to [ {v}_{1} , {v}_{2} , {v}_{3} , … , {v}_{k} ] & ( Math 4 )\end{matrix}$$

By referring to the outcomes in the log data individually corresponding to the k vectors, the ratio of wins for the first player in k is output as the result of tide evaluation.

As described above, this example makes it possible to realize tide evaluation that is convincing to anyone by using a huge amount of log data as evidence, like “M out of N players won after this type of situation”.

### Advantages

The greatest advantage of this example is tide evaluation that is convincing to anyone, like “M out of N players won after this type of situation”, is realized. In addition to such evidence-based tide evaluation, the present invention has the following advantages.
High-speed: As compared with the conventional, strict neighbor search, the approximate nearest neighbor search adopted in this example runs at extremely high speed. Specifically, it is possible to retrieve similar vectors from among billions of vectors with a latency of a few milliseconds, which makes it possible to evaluate the tide following real-time esports webcasting.
Incremental updating: Since the approximate nearest neighbor search adopted in this example is a search engine, unlike machine learning, data addition does not exert any considerable negative influence such as a reduction in the accuracy on inference results. Thus, it is possible to perform incremental updating safely. With this feature, presupposing that meta-information such as best actions constantly change as a game is run and as tactical information becomes available, it is possible to incorporate the latest trends in tactics into the tide evaluation AI in this example in the form of updating of databases for the purpose of approximate nearest neighbor search.
Versatility: The learning method according to this example is widely applicable to turn-based battles, which makes it possible to apply AI that simulates human play tendencies to a variety of genres.

### Modification

As an application of this example, it is possible to give advice in real time during a game, like “a master (advanced player) would choose this as the next action”, by retrieving, on the basis of a specific situation, actions that immediately followed the specific situation. For example, as a handicap for novices, it is possible to implement a new form of handicap, like “support from AI may be received N times at most”. In this case, a player can receive the abovementioned advice N times at most.

Although embodiments of the present invention have been described above with reference to the drawings, the embodiments are examples of the present invention, and various configurations other than those described above may be adopted. The configurations of the embodiments described above may be combined with each other, or the configurations may be partially replaced with other configurations. Furthermore, various changes may be added to the configurations of the embodiments described above within a range not departing from the spirit thereof. Furthermore, the configurations or processing disclosed in the context of the individual embodiments or the modification described above may be combined with each other.

Furthermore, although a plurality of steps (processing steps) are shown in order in the plurality of flowcharts used for the descriptions given above, the order of execution of the steps that are executed in each of the embodiments is not limited to the order shown. In each of the embodiments, the shown order of steps may be changed within a range in which no problem arises in content. Furthermore, the individual embodiments described above may be combined within a range in which no contradiction arises in content.

Some or all of the embodiments described above may be described, without limitation, as appended below.
1. A tide evaluation device including:
   a reference-data storage unit that stores reference data, the reference data being data generated on the basis of log data of a plurality of game plays executed in the past, and the reference data including a plurality of combinations of reference state information representing a game state in a game play and a game result determined following the game state;
   an acquisition unit that acquires subject state information representing a game state at a timing for evaluating a game play to be evaluated;
   a search unit that extracts the reference state information similar to the subject state information from among the reference data;
   an evaluation unit that evaluates the tide of a game at the timing for evaluating the game play to be evaluated on the basis of the game results associated with the reference state information extracted; and
   an output unit that outputs the result of the evaluation.
2. A tide evaluation device according to 1, wherein:
   the evaluation unit measures the game results associated with the reference state information extracted; and
   the output unit outputs the result of the measurement as the result of the evaluation.
3. A tide evaluation device according to 1 or 2, wherein the search unit extracts the reference state information similar to the subject state information from among the reference data by way of nearest neighbor search or approximate nearest neighbor search.
4. A tide evaluation device according to any one of 1 to 3, wherein:
   the reference data are grouped on the basis of characteristics of the game plays;
   the reference-data storage unit stores the reference data on a per-group basis; and
   the search unit identifies the group to which the game play to be evaluated belongs on the basis of characteristics of the game play to be evaluated, and extracts the reference state information similar to the subject state information from among the reference data that belong to the group identified.
5. A tide evaluation device according to 4, wherein:
   the game plays are plays of a game in which a first player and a second player alternately perform actions;
   the reference data are grouped on the basis of the number of actions as counted beginning from the first action;
   the acquisition unit further acquires the number of actions at the timing for evaluating the game play to be evaluated; and
   the search unit extracts the reference state information similar to the subject state information from among the reference data that belong to the group corresponding to the number of actions at the timing for evaluation.
6. A tide evaluation device according to 5, wherein the search unit extracts the reference state information similar to the subject state information from among the reference data that belong to the groups corresponding to the numbers of actions included in the range of (the number of actions at the timing for evaluation−α) to (the number of actions at the timing for evaluation+α).
7. A tide evaluation device according to any one of 4 to 6, wherein:
   the game plays are plays of a game in which a first player and a second player each select a character;
   the reference data are grouped on the basis of the combination of the character selected by the first player and the character selected by the second player;
   the acquisition unit further acquires information indicating the character selected by the first player and the character selected by the second player in the game play to be evaluated; and
   the search unit extracts the reference state information similar to the subject state information from among the reference data that belong to the group corresponding to the combination of the character selected by the first player and the character selected by the second player in the game play to be evaluated.
8. A tide evaluation device according to any one of 4 to 7, wherein:
   the reference data are grouped on the basis of the combination of player characteristics of a first player and player characteristics of a second player;
   the acquisition unit further acquires the player characteristics of the first player and the player characteristics of the second player in the game play to be evaluated; and
   the search unit extracts the reference state information similar to the subject state information from among the reference data that belong to the group corresponding to the combination of the player characteristics of the first player and the player characteristics of the second player in the game play to be evaluated.
9. A tide evaluation device according to any one of 1 to 8, further including a reference-data creation unit that extracts, from among the log data of a plurality of game plays executed by a plurality of players in the past, the log data of game plays executed in the past by the players whose player characteristics satisfy a prescribed condition, and creates the reference data on the basis of the log data extracted.
10. A tide evaluation device according to any one of 1 to 9, wherein:
   game states in the game play are expressed in the form of a multi-dimensional vector;
   the reference state information and the subject state information include the multi-dimensional vector;
   the multi-dimensional vector includes a vector relating to an object that is used in the game; and
   in the case where the multi-dimensional vector included in the subject state information includes a vector relating to the new object, the search unit, by using prescribed transformation information, transforms a vector relating to the new object in the multi-dimensional vector into a vector relating to the other object that is different from the new object, and extracts the reference state information similar to the subject state information by using the multi-dimensional vector transformed.
11. A tide evaluation method wherein a computer executes:
   storing reference data, the reference data being data generated on the basis of log data of a plurality of game plays executed in the past, and the reference data including a plurality of combinations of reference state information representing a game state in a game play and a game result determined following the game state;
   an acquisition step of acquiring subject state information representing a game state at a timing for evaluating a game play to be evaluated;
   a search step of extracting the reference state information similar to the subject state information from among the reference data;
   an evaluation step of evaluating the tide of a game at the timing for evaluating the game play to be evaluated on the basis of the game results associated with the reference state information extracted; and
   an output step of outputting the result of the evaluation.
12. A program for causing a computer to function as:
   a reference-data storage means for storing reference data, the reference data being data generated on the basis of log data of a plurality of game plays executed in the past, and the reference data including a plurality of combinations of reference state information representing a game state in a game play and a game result determined following the game state;
   an acquisition means for acquiring subject state information representing a game state at a timing for evaluating a game play to be evaluated;
   a search means for extracting the reference state information similar to the subject state information from among the reference data;
   an evaluation means for evaluating the tide of a game at the timing for evaluating the game play to be evaluated on the basis of the game results associated with the reference state information extracted; and
   an output means for outputting the result of the evaluation.

This application claims priority based on Japanese Patent Application No. 2022-065152 filed on 11 Apr. 2022, and the entire disclosure thereof is incorporated herein.

### REFERENCE SIGNS LIST

10 Tide evaluation device
11 Reference-data storage unit
12 Acquisition unit
13 Search unit
14 Evaluation unit
15 Output unit
16 Log-data storage unit
17 Reference-data creation unit
1A Processor
2A Memory
3A Input/output interface
4A Peripheral circuit
5A Bus

What is claimed is:

1. A tide evaluation device comprising:
a reference-data storage unit that stores reference data, the reference data being data generated on the basis of log data of a plurality of game plays executed in the past, and the reference data including a plurality of combinations of reference state information representing a game state in a game play and a game result determined following the game state;
an acquisition unit that acquires subject state information representing a game state at a timing for evaluating a game play to be evaluated;
a search unit that extracts the reference state information similar to the subject state information from among the reference data;
an evaluation unit that evaluates the tide of a game at the timing for evaluating the game play to be evaluated on the basis of the game results associated with the reference state information extracted; and
an output unit that outputs the result of the evaluation.

2. A tide evaluation device according to claim 1, wherein:
the evaluation unit measures the game results associated with the reference state information extracted; and
the output unit outputs the result of the measurement as the result of the evaluation.

3. A tide evaluation device according to claim 1, wherein the search unit extracts the reference state information similar to the subject state information from among the reference data by way of nearest neighbor search or approximate nearest neighbor search.

4. A tide evaluation device according to claim 1, wherein:
the reference data are grouped on the basis of characteristics of the game plays;
the reference-data storage unit stores the reference data on a per-group basis; and
the search unit identifies the group to which the game play to be evaluated belongs on the basis of characteristics of the game play to be evaluated, and extracts the reference state information similar to the subject state information from among the reference data that belong to the group identified.

5. A tide evaluation device according to claim 3, wherein:
the reference data are grouped on the basis of characteristics of the game plays;
the reference-data storage unit stores the reference data on a per-group basis; and
the search unit identifies the group to which the game play to be evaluated belongs on the basis of characteristics of the game play to be evaluated, and extracts the reference state information similar to the subject state information from among the reference data that belong to the group identified.

6. A tide evaluation device according to claim 4, wherein:
the game plays are plays of a game in which a first player and a second player alternately perform actions;
the reference data are grouped on the basis of the number of actions as counted beginning from the first action;
the acquisition unit further acquires the number of actions at the timing for evaluating the game play to be evaluated; and
the search unit extracts the reference state information similar to the subject state information from among the reference data that belong to the group corresponding to the number of actions at the timing for evaluation.

7. A tide evaluation device according to claim 5, wherein:
the game plays are plays of a game in which a first player and a second player alternately perform actions;
the reference data are grouped on the basis of the number of actions as counted beginning from the first action;
the acquisition unit further acquires the number of actions at the timing for evaluating the game play to be evaluated; and
the search unit extracts the reference state information similar to the subject state information from among the reference data that belong to the group corresponding to the number of actions at the timing for evaluation.

8. A tide evaluation device according to claim 6, wherein the search unit extracts the reference state information similar to the subject state information from among the reference data that belong to the groups corresponding to the numbers of actions included in the range of (the number of actions at the timing for evaluation−α) to (the number of actions at the timing for evaluation+α).

9. A tide evaluation device according to claim 7, wherein the search unit extracts the reference state information similar to the subject state information from among the reference data that belong to the groups corresponding to the numbers of actions included in the range of (the number of actions at the timing for evaluation−α) to (the number of actions at the timing for evaluation+α).

10. A tide evaluation device according to claim 4, wherein:
the game plays are plays of a game in which a first player and a second player each select a character;
the reference data are grouped on the basis of the combination of the character selected by the first player and the character selected by the second player;
the acquisition unit further acquires information indicating the character selected by the first player and the character selected by the second player in the game play to be evaluated; and
the search unit extracts the reference state information similar to the subject state information from among the reference data that belong to the group corresponding to the combination of the character selected by the first player and the character selected by the second player in the game play to be evaluated.

11. A tide evaluation device according to claim 4, wherein:
the reference data are grouped on the basis of the combination of player characteristics of a first player and player characteristics of a second player;
the acquisition unit further acquires the player characteristics of the first player and the player characteristics of the second player in the game play to be evaluated; and
similar to the subject state information from among the reference data that belong to the group corresponding to the combination of the player characteristics of the first player and the player characteristics of the second player in the game play to be evaluated.

12. A tide evaluation device according to claim 1, further comprising a reference-data creation unit that extracts, from among the log data of a plurality of game plays executed by a plurality of players in the past, the log data of game plays executed in the past by the players whose player characteristics satisfy a prescribed condition, and creates the reference data on the basis of the log data extracted.

13. A tide evaluation device according to claim 1, wherein:
game states in the game play are expressed in the form of a multi-dimensional vector;
the reference state information and the subject state information include the multi-dimensional vector;
the multi-dimensional vector includes a vector relating to an object that is used in the game; and
in the case where the multi-dimensional vector included in the subject state information includes a vector relating to a new object, the search unit, by using prescribed transformation information, transforms a vector relating to the new object in the multi-dimensional vector into a vector relating to the other object that is different from the new object, and extracts the reference state information similar to the subject state information by using the multi-dimensional vector transformed.

14. A tide evaluation method wherein a computer executes:
storing reference data, the reference data being data generated on the basis of log data of a plurality of game plays executed in the past, and the reference data including a plurality of combinations of reference state information representing a game state in a game play and a game result determined following the game state;
an acquisition step of acquiring subject state information representing a game state at a timing for evaluating a game play to be evaluated;
a search step of extracting the reference state information similar to the subject state information from among the reference data;
an evaluation step of evaluating the tide of a game at the timing for evaluating the game play to be evaluated on the basis of the game results associated with the reference state information extracted; and
an output step of outputting the result of the evaluation.

15. A program for causing a computer to function as:
a reference-data storage means for storing reference data, the reference data being data generated on the basis of log data of a plurality of game plays executed in the past, and the reference data including a plurality of combinations of reference state information representing a game state in a game play and a game result determined following the game state;
an acquisition means for acquiring subject state information representing a game state at a timing for evaluating a game play to be evaluated;
a search means for extracting the reference state information similar to the subject state information from among the reference data;
an evaluation means for evaluating the tide of a game at the timing for evaluating the game play to be evaluated on the basis of the game results associated with the reference state information extracted; and
an output means for outputting the result of the evaluation.
